(19) United States
(12) Patent Application Publication
(10) Pub. No.: US 2005/0286087 A1
(43) Pub. Date: Dec. 29, 2005

(54) Image outputting system, image outputting method, program for executing the method and a computer-readable information recording medium on which the program is recorded

(76) Inventor: Sachiko Hirano, Tokyo (JP)

Correspondence Address: CANTOR COLBURN, LLP, 55 GRIFFIN ROAD SOUTH, BLOOMFIELD, CT, 06002, US

(21) Appl. No.: 11/156,186

(22) Filed: Jun. 17, 2005

(30) Foreign Application Priority Data
Jun. 24, 2004 (JP) JP2004-186331

(51) Int. Cl. G06K 15/00

(52) U.S. Cl. 358/3.27; 382/266; 358/3.06

(57) ABSTRACT

There is described an image outputting system for outputting an image formed on a recording medium, based on image data transmitted through a network. The system includes: an image outputting apparatus and a controlling apparatus that receives the image data to output processed-image data generated from the image data, and controls the image outputting apparatus so as to form the image on the recording medium, based on the processed-image data. The controlling apparatus includes: an extracting section to extract an edge, defined as a boundary at which a density value varies from an intermediate tone area to a high density area where the density value is higher than that of the intermediate tone area, based on whole density values; and an correcting section to correct a density value, residing within the intermediate tone area and located in a vicinity of the edge, based on a correction value determined in advance.

This application is based on Japanese Patent Application NO. 2004-186331 filed on Jun. 24, 2004 in Japanese Patent Office, the entire content of which is hereby incorporated by reference.

### BACKGROUND OF THE INVENTION

The present invention relates to an image outputting system, an image outputting method for creating a color proof for checking the final form of the printed matter beforehand or for creating the final product using an electro-photographic image outputting apparatus. The invention also relates to the image outputting method, a program for executing the foregoing method and a computer-readable information recording medium on which the program is recorded.

In recent years, DTP (Desk Top Publishing) and the like have been becoming more popular, and as a result image editing and page adding operations using a computer are becoming standard, and full digital editing is no longer rare.

In these types of processes, image setter output in which image data which has been subjected to page editing is directly output to film, or CTP (computer to plate) output in which image recording is performed directly on the printing plate and CTC (computer to cylinder) output in which image recording is performed directly on the printing plate which is wound onto the cylinder of the printer are being performed with the object of improving efficiency.

Furthermore, proofs are created and used in 3 main applications in the correction processes in these types of printing processes, and these are (1) error checking at the operation site, or in other words, internal correction; (2) external correction which is submitted for checking of the completed work by the designer or the order holder; (3) print sample that is submitted to the person in charge of printing as a sample of final print material. The final form of the printed material was checked beforehand to determine if there are errors in the document layout, in color, or in text.

In this system, there was the problem that some film output and printing plate output must be performed just for proof checking, and when proofing is done using print proofs and other proof material, film and printing plates are wasted and many unnecessary operations had to be performed.

As a result, in the process of performing full digital image creation and editing using a computer in particular, there is demand for systems which performs direct color image output called DDCP (Direct Digital Color Proof) or DCP (Digital Color Proof). Prior to recording from the digital image data processed on the computer onto the plate making film using an image setter or the like, or performing final printing operations for creating a direct printing plate using CTP, or performing direct image recording on the printing plate that is wound on the cylinder of the printer using CTC, a color proof which reproduces output showing the digital image that was processed by the computer is created, and the picture pattern, tone and the text and the like were checked.

Another example of a device for creating a color proof is a color proof creation device in which light spots composing plural lights having combinations of different wavelengths such as R, G and B are exposed on a silver salt color light-sensitive material based on halftone dot image data for each of the color separated halftone dot originals, and halftone dot images are reproduced and a color proof is created by performing color development for dots of each of the 3 fundamental colors Y, M and C.

Meanwhile, there is a comprehensive layout (abbreviated and referred to as comp hereinafter), which does not require the image quality of a color proof, but shows overall design and is used for obtaining approval from an advertiser for example. In the past, a color laser printer using an electro-photographic system was used for creating this comp.

However, with the increase in quality of the color laser printer in recent years, high speed and high grade color output has become possible at a low cost and as a result, there is increasing demand for not only comp applications, but also DCCP applications. That is to say there is increasing demand for use of color laser printers in creating color proofs, as well increased demand for the output from the color laser printer to be used as final product.

However, generally speaking, in electro-photographic laser printer, the photoreceptor drum generates a low electric field around the static charge holding portion due to electrostatic properties of the receptor drum, and the photoreceptor drum is developed in this state by the developing device to form a visible image, and thus low density or blank portions are sometimes formed. It has been proposed for example, that the image data is corrected such that the density reduction is suppressed in the vicinity where the intermediate tone area contacts the background portion. In this vicinity the output image changes from the intermediate tone area to the background portion in the sub-scanning direction (for instance, set forth in Patent Document 1 and Patent Document 2).

[Patent Document 1]
Tokkai 2000-125135 (Japanese Non-Examined Patent Publication)

[Patent Document 2]
Tokkai 2004-54103 (Japanese Non-Examined Patent Publication)

However, due to the abovementioned increased image quality of the color laser printer in recent years, and the increasing density in particular, there is a large difference in density between the intermediate tone area and the high density area, and density reduction of the intermediate tone area is conspicuous at the edge vicinity where the intermediate tone area and the high density area contact each other. This poses a problem with respect to image quality in the case of color proofs or final products in particular.

Furthermore, because density reduction of the intermediate tone area in the above-described edge vicinity is reversed due to the electric potential of the magnetic particles that are exposed after the toner that attached to the halftone dots of the low density section in the sub-scanning direction of the color laser printer attaches in large quantities to the back of the high density area, density reduction tends to occur in the edge vicinity where the intermediate tone area and the high density area contact each other in the sub-scanning direction.

### SUMMARY OF THE INVENTION

To overcome the abovementioned drawbacks in conventional image-outputting systems, it is an object of the present invention to provide an image outputting system, which avoids the generation of density reduction in the intermediate tone area in the vicinity of contact with the high density area of the image output from the electro-photographic image outputting apparatus, and which makes it possible to output high quality images. The object is also to provide an image outputting method, a program for executing the foregoing method and a computer-readable information recording medium on which the program is recorded.

Accordingly, to overcome the cited shortcomings, the abovementioned object of the present invention can be attained by image outputting systems and methods described as follow.
(1) A system for outputting an image formed on a recording medium, based on image data transmitted through a network, the system comprising: an image outputting apparatus to output the image formed on the recording medium; and a controlling apparatus that receives the image data transmitted through the network to output processed-image data generated from the image data, and controls the image outputting apparatus so as to form the image on the recording medium, based on the processed-image data; wherein the controlling apparatus includes: an extracting section to extract an edge, defined as a boundary at which a density value varies from an intermediate tone area to a high density area where the density value is higher than that of the intermediate tone area, based on whole density values represented by the image data; and an correcting section to correct a density value, residing within the intermediate tone area and located in a vicinity of the edge, based on a correction value determined in advance.
(2) The system of item 1, wherein, in the image outputting apparatus, a laser beam, modulated according to the processed-image data, is scanned onto the recording medium in a main scanning direction, while the recording medium is moving in a sub-scanning direction being orthogonal to the main scanning direction, in order to form the image on the recording medium by repeating main-scanning operations of the laser beam and moving operations of the recording medium in the sub-scanning direction; and wherein the extracting section extracts the edge, at which the density value varies from the intermediate tone area to the high density area in a direction corresponding to the sub-scanning direction.
(3) The system of item 1, wherein, the density value of the high density area is equal to or greater than such a value that is higher than that of the intermediate tone area by a predetermined value.
(4) The system of item 1, wherein the correcting section corrects the density value, being apart from the edge by a predetermined distance or another distance longer than the predetermined distance, based on the correction value determined in advance.
(5) The system of item 4, wherein the predetermined distance is in a range of 0.08-0.4 mm.
(6) The system of item 1, wherein the larger a distance from the edge becomes, the smaller the correcting section makes the correction value, so as to correct the density value.
(7) The system of item 1, wherein the correction value is determined corresponding to any one of a first density value belonging to the intermediate tone area, a second density value belonging to the high density area, and a combination of the first density value and the second density value.
(8) The system of item 1, wherein the image outputting apparatus outputs a full color image, serving as the image, formed by overlapping a plurality of unicolor images with each other onto the recording medium, and wherein the image data corresponds to each of the plurality of unicolor images, and with respect to each of the plurality of unicolor images, the controlling apparatus controls the image outputting apparatus so as to correct the density value, based on the correction value determined in advance for every unicolor.
(9) A system for outputting an image formed on a recording medium, based on image data transmitted through a network, the system comprising: an image outputting apparatus to output the image formed on the recording medium; and a controlling apparatus that receives the image data transmitted through the network to output processed-image data generated from the image data, and controls the image outputting apparatus so as to form the image on the recording medium, based on the processed-image data; wherein, in the image outputting apparatus, a laser beam, modulated according to the processed-image data, is scanned onto the recording medium in a main scanning direction, while the recording medium is moving in a sub-scanning direction being orthogonal to the main scanning direction, in order to form the image on the recording medium by repeating main-scanning operations of the laser beam and moving operations of the recording medium in the sub-scanning direction; and wherein the image outputting apparatus is capable of changing an image forming direction of the image to be formed on the recording medium, corresponding to an image size and a size of the recording medium; and wherein the controlling apparatus includes: a direction confirming section to confirm the image forming direction of the image to be formed on the recording medium, based on the image data, so as to determine the image forming direction as the sub-scanning direction; an extracting section to extract an edge, defined as a boundary at which a density value varies from an intermediate tone area to a high density area where the density value is higher than that of the intermediate tone area, in the image forming direction determined by the direction confirming section, based on whole density values represented by the image data; and an correcting section to correct a density value, residing within the intermediate tone area and located in a vicinity of the edge, based on a correction value determined in advance.
(10) The system of item 9, wherein, the density value of the high density area is equal to or greater than such a value that is higher than that of the intermediate tone area by a predetermined value.
(11) The system of item 9, wherein the correcting section corrects the density value, being apart from the edge by a predetermined distance or another distance longer than the predetermined distance, based on the correction value determined in advance.
(12) The system of item 11, wherein the predetermined distance is in a range of 0.08-0.4 mm.
(13) The system of item 9, wherein the larger a distance from the edge becomes, the smaller the correcting section makes the correction value, so as to correct the density value.
(14) The system of item 9, wherein the correction value is determined corresponding to any one of a first density value belonging to the intermediate tone area, a second density value belonging to the high density area, and a combination of the first density value and the second density value.
(15) The system of item 9, wherein the image outputting apparatus outputs a full color image, serving as the image, formed by overlapping a plurality of unicolor images with each other onto the recording medium, and wherein the image data corresponds to each of the plurality of unicolor images, and with respect to each of the plurality of unicolor images, the controlling apparatus controls the image outputting apparatus so as to correct the density value, based on the correction value determined in advance for every unicolor.
(16) A method for outputting an image formed on a recording medium, based on image data transmitted through a network, the method comprising the steps of: receiving the image data transmitted through the network; extracting an edge, defined as a boundary at which a density value varies from an intermediate tone area to a high density area where the density value is higher than that of the intermediate tone area, based on whole density values represented by the image data; correcting a density value, residing within the intermediate tone area and located in a vicinity of the edge, based on a correction value determined in advance, so as to generate processed-image data generated from the image data; and outputting the image that is formed on the recording medium, based on the processed-image data generated in the correcting step.
(17) The method of item 16, wherein a laser beam, modulated according to the processed-image data, is scanned onto the recording medium in a main scanning direction, while the recording medium is moving in a sub-scanning direction being orthogonal to the main scanning direction, in order to form the image on the recording medium by repeating main-scanning operations of the laser beam and moving operations of the recording medium in the sub-scanning direction; and wherein an image forming direction of the image to be formed on the recording medium can be changed, corresponding to an image size and a size of the recording medium; and the method further comprising the steps of: confirming the image forming direction of the image to be formed on the recording medium, based on the image data; and determining the image forming direction as the sub-scanning direction; wherein, in the extracting step, the edge is extracted in the image forming direction determined in the determining step.
(18) The method of item 16, wherein, the density value of the high density area is equal to or greater than such a value that is higher than that of the intermediate tone area by a predetermined value.
(19) The method of item 16, wherein the density value, being apart from the edge by a predetermined distance or another distance longer than the predetermined distance, is corrected, based on the correction value determined in advance.
(20) The method of item 19, wherein the predetermined distance is in a range of 0.08-0.4 mm.

Further, to overcome the abovementioned problems, other image outputting systems and methods, embodied in the present invention, will be described as follow:
(21) An image outputting system, characterized in that,
   the image outputting system, including an image outputting apparatus which outputs an image on a image recording medium, is provided with:
   an extracting means, that receives image data, for extracting a boundary at which a density value varies from an intermediate tone area to a high density area where the density value is higher than that of the intermediate tone area, as an edge, based on whole density values represented by the image data;
   an correcting means for correcting a density value, residing within the intermediate tone area of said image data and located in a vicinity of the edge, based on a correction value determined in advance; and
   an image output controlling means for controlling the image outputting apparatus so as to output the image on the image recording medium based on the corrected image data.
(22) The image outputting system, recited in item 21, characterized in that,
   the image outputting apparatus is such an apparatus that scans a laser beam incident into a photosensitive material for forming the image in a main scanning direction while moving the photosensitive material in a sub-scanning direction being orthogonal to the main scanning direction, in order to conduct an image forming operation by repeating main-scanning operations of the laser beam and moving operations of the photosensitive material in the sub-scanning direction, and
   the extracting means extracts the boundary, at which the density value varies from the intermediate tone area to the high density area in a direction corresponding to the sub-scanning direction, as the edge.
(23) An image outputting system, characterized in that,
   in the image outputting system provided with an image recording medium and including the image outputting apparatus for forming an image on the image recording medium, which is capable of changing an image forming direction relative to the image recording medium, corresponding to an image size and a size of the recording medium, when the image outputting apparatus conducts an image forming operation by scanning a laser beam incident into a photosensitive material for forming an image in a main scanning direction while moving the photosensitive material in a sub-scanning direction being orthogonal to the main scanning direction, in order to conduct an image forming operation by repeating main-scanning operations of the laser beam and moving operations of the photosensitive material in the sub-scanning direction, the the image outputting system is provided with:
   a direction confirming means, that receives image data, for confirming the image forming direction of the image to be formed by the image outputting apparatus, based on the image data, and for judging a direction corresponding to the sub-scanning direction on the image data, based on the confirmed result;
   an extracting means for extracting a boundary at which a density value varies from an intermediate tone area to a high density area where the density value is higher than that of the intermediate tone area in the judged direction, as an edge, based on whole density values represented by the image data;
   an correcting means for correcting a density value, residing within the intermediate tone area of said image data and located in a vicinity of the edge, based on a correction value determined in advance; and
   an image output controlling means for controlling the image outputting apparatus so as to output the image on the image recording medium based on the corrected image data.
(24) The image outputting system, recited in any one of items 21-23, characterized in that,
   the extracting means extracts the boundary, at which the density value varies from the intermediate tone area to the high density area where the density value is equal to or greater than such a value that is higher than that of the intermediate tone area by a predetermined value, as the edge.
(25) The image outputting system, recited in any one of items 21-23, characterized in that,
   the extracting means extracts the boundary, at which the density value varies from the intermediate tone area to a solid tone area, as the edge.
(26) The image outputting system, recited in any one of items 21-25, characterized in that,
   the correcting means corrects the density value, being apart from the edge by a predetermined distance or another distance longer than the predetermined distance in the intermediate tone area of said image data, based on the correction value determined in advance.
(27) The image outputting system, recited in item 26, characterized in that
   the predetermined distance is in a range of 0.08-0.4 mm.
(28) The image outputting system, recited in any one of items 21-27, characterized in that,
   according as a distance from the edge is getting large, the correcting means conduct the correcting operation by making the correction value smaller.
(29) The image outputting system, recited in any one of items 21-28, characterized in that,
   the correction value is determined corresponding to a density value of the intermediate tone area, and
   the correcting means conduct the correcting operation, based on the correction value corresponding to the density value of the intermediate tone area forming the edge.
(30) The image outputting system, recited in any one of items 21-28, characterized in that,
   the correction value is determined corresponding to a density value of the high density area, and
   the correcting means conduct the correcting operation, based on the correction value corresponding to the density value of the high density area forming the edge.
(31) The image outputting system, recited in any one of items 21-28, characterized in that,
   the correction value is determined corresponding to a combination of a density value of the intermediate tone area and a density value of the high density area, and
   the correcting means conduct the correcting operation, based on the correction value corresponding to the density value of the intermediate tone area and the density value of the high density area, which form the edge.
(32) The image outputting system, recited in any one of items 21-31, characterized in that,
   the image outputting apparatus outputs a color image by overlapping images of plural colors with each other onto the image recording medium, and
   the image data represent the density value with respect to each of the plural colors, and
   the extracting means extracts the boundary as the edge with respect to each of the plural colors, and
   the correcting means conduct the correcting operation with respect to each of the plural colors, and
   the image outputting apparatus outputs the color image on the image recording medium, based on the image data corrected with respect to each of the plural colors.
(33) An image outputting method, characterized in that,
   the image outputting method, for outputting an image on a image recording medium in an image outputting apparatus, includes the steps of:
   receiving the image data;
   extracting a boundary, at which a density value varies from an intermediate tone area to a high density area where the density value is higher than that of the intermediate tone area, as an edge, based on whole density values represented by the image data;
   correcting a density value in a vicinity of the edge among the intermediate tone area of the image data, based on a correction value determined in advance; and
   controlling the image outputting apparatus, based on the corrected image data, so as to output the image onto the image recording medium.
(34) An image outputting method, characterized in that,
   in the image outputting apparatus, which is provided with an image recording medium, and which is capable of changing an image forming direction relative to the image recording medium, corresponding to an image size and a size of the recording medium, when the image outputting apparatus conducts an image forming operation by scanning a laser beam incident into a photosensitive material for forming an image in a main scanning direction while moving the photosensitive material in a sub-scanning direction being orthogonal to the main scanning direction, in order to conduct an image forming operation by repeating main-scanning operations of the laser beam and moving operations of the photosensitive material in the sub-scanning direction, the image outputting method, for forming the image on the image recording medium, includes the steps of:
   receiving the image data;
   confirming the image forming direction of the image based on the image data in the image outputting apparatus;
   judging a direction corresponding to the image forming direction on the image data, based on the confirming result;
   extracting a boundary, at which a density value varies from an intermediate tone area to a high density area where the density value is higher than that of the intermediate tone area, in the judged direction, as an edge, based on whole density values represented by the image data;
   correcting a density value in a vicinity of the edge among the intermediate tone area of the image data, based on a correction value determined in advance; and
   controlling the image outputting apparatus, based on the corrected image data, so as to output the image onto the image recording medium.
(35) A program for making a computer conduct the image outputting method recited in item 33 or item 34.
(36) An information recording medium in which the program recited in item 35 is recorded in a computer readable manner.

### BRIEF DESCRIPTION OF THE DRAWINGS

Other objects and advantages of the present invention will become apparent upon reading the following detailed description and upon reference to the drawings in which:

FIG. 1 is a block diagram, which shows the system configuration of the first embodiment of the image outputting system embodied in the present invention;

FIG. 2 is a block diagram showing the control configuration of the controlling apparatus of the image outputting system shown in FIG. 1;

FIG. 3 is a functional block diagram showing the control configuration of the controlling apparatus in the image outputting system shown in FIG. 1;

FIG. 4 is cross-sectional diagram showing the schematic device configuration for the color laser printer serving as the image outputting system shown in FIG. 1;

FIG. 5 is a diagram for explaining the electric potential state on the surface of the photoreceptor of the color laser printer.

FIG. 6 is a flowchart showing the steps in the image forming method of the first embodiment;

FIG. 7 is an explanatory diagram for explaining the raster data;

FIG. 8 is an explanatory diagram for describing the edge, which is the boundary between the intermediate tone area and the high density area;

FIG. 9(a), FIG. 9(b), FIG. 9(c) and FIG. 9(d) are explanatory diagrams, each of which is used for explaining an example of correcting operation for the density value of the pixels within the intermediate tone area in the vicinity of the extracted edge;

FIG. 10 shows an example of the correction table used for correcting the density value of the pixels of the intermediate tone area in the vicinity of the edge the edge;

FIG. 11(a), FIG. 11(b), FIG. 11(c) and FIG. 11(d) are explanatory diagrams, each of which is used for explaining an example of correcting operation for the density value of the pixels within the intermediate tone area in the vicinity of the extracted edge;

FIG. 12(a), FIG. 12(b), FIG. 12(c), FIG. 12(d) and FIG. 12(e) are explanatory diagrams for explaining conversion of the raster data to the halftone dot image data using the halftone dot reference data;

FIG. 13 is a functional block diagram showing the control configuration of the controlling apparatus of the image outputting system of the second embodiment; and

FIG. 14 is a flowchart showing the steps of the image output method of the second embodiment.

### DETAILED DESCRIPTION OF THE PREFERRED EMBODIMENTS

### First Embodiment

The following is a detailed description of the first embodiment of the image outputting system of this invention with reference to drawings.

(System Configuration)

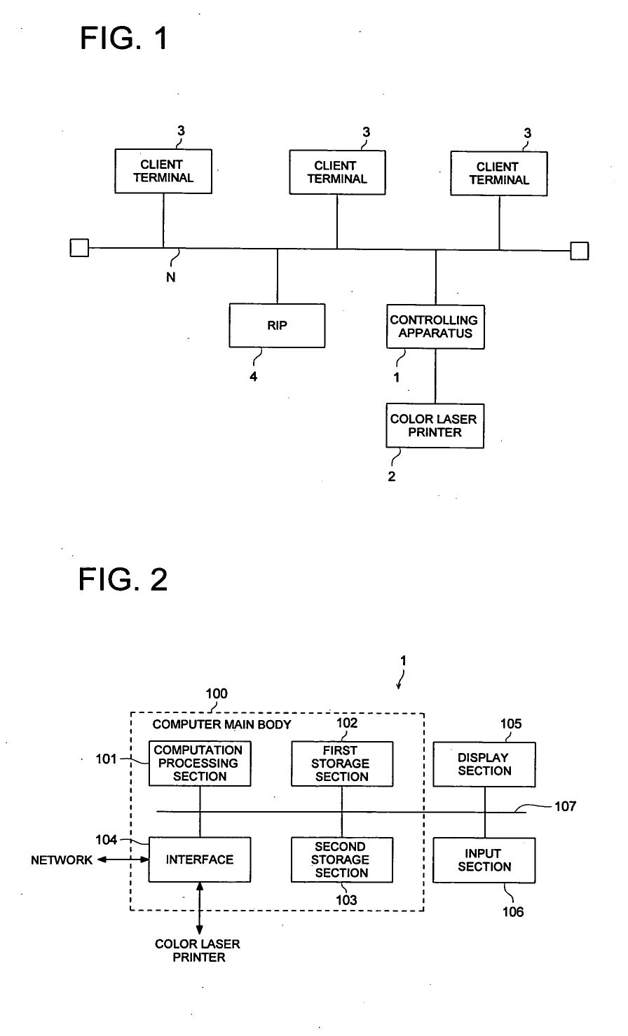

Firstly the overall configuration of the image outputting system of this embodiment is described with reference to FIG. 1. FIG. 1 is a figure showing the overall configuration of the image outputting system.

As shown in FIG. 1, the image outputting system includes a control section 1 that generates halftone dots from image data that is sent from the client terminal 3 or the RIP (Raster Image Processor) 4 into halftone, and sends the image data which has been converted to halftone along with the output command signals to the color laser printer 2 which is the image outputting apparatus and the color laser printer 2 which outputs halftone dot images based on the output command signals and the image data which has been converted to halftone from the controlling apparatus 1, and both are connected to each other via the network N.

The client terminal 3 is a PC (personal computer) and in addition to the computer main body, the keyboard, the monitor and the like, the client terminal 3 also includes an image input device such as an image scanner and the like (not shown). Application software is included in the computer main body and image data is created by executing applications software and the image data is sent to the RIP 4 of the controlling apparatus 1 via the network N. In addition, a plurality of this type of client terminals is usually provided. (FIG. 1 shows 3 client terminals, but the system may be configured with only 1 client terminal or with any desired amount of client terminals.) Furthermore, the types of image data that are created and sent at the client terminal 3 include vector data which shows parameters called vector graphics for the objects displayed as images as point coordinates and lines or planes joining these points; font information which shows highlight colors, special effects and text format as well as drawing information for size and the like of the fonts. Another type of image data is raster data which is called bit map graphics and in which the pixels displayed by the density value of each color are arranged. The density value may for example 0% for white and 100% for solid color, and the intermediate tones between white and solid color are halftone % indicated in gradual levels by %, or alternatively white may be 0 and 255 is solid and the intermediate tones in between white and beta are gradual tone values indicated by gradual numerical values.

The RIP 4 includes a server or the like, and functions as a processor for receiving vector data sent from the client terminal 3 via the network N, and for analyzing information such as image and text font and the like and performing conversion to raster data.

As shown in FIG. 2, the controlling apparatus 1 includes a computer main body 100, a display section 105 such as a monitor or the like, an input section 106 such as a keyboard or the like, and the computer main body 100 includes the computation processing section 101 which is formed of a microprocessor, a first storage section 102 which is formed of memory, a second storage section 103 which is formed of a hard disk, an interface 104 which is for external communication, and an internal bus 107 makes it possible for the sections to communicate with each other. Furthermore, the second storage section 103 has incorporated therein, prescribed programs for image output processing, and the computation processing section 101 executes the programs and performs the image processing described hereinafter. In addition, the input section 106 includes a portable device (not shown) for reading information from the information recording medium, such as a floppy (registered trademark) disk, a CD-ROM, magnetic recording tape and the like.

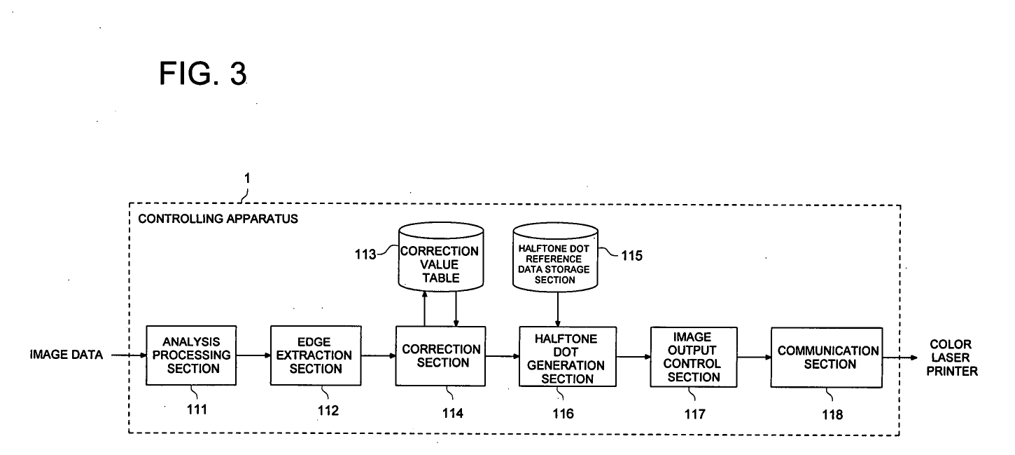

The control configuration of the controlling apparatus 1 will be described using the functional block diagram of the controlling apparatus 1 shown in FIG. 3. The controlling apparatus 1 includes the function for each of the sections shown in FIG. 3 using the configuration shown in FIG. 2. (The details of the process performed by each of the sections will be described when describing the image output method.)

The analysis processing section 111 receives the image data sent from the client terminal 3 or the RIP 4, analyses the image data, and in the case where the image data is vector data, information such as image and text font and the like are analyzed and raster data is generated.

The edge extraction section 112 (extraction section) extracts the edge which is boundary between the intermediate tone area and the high density area of the raster data, and the correction section 114 refers to the correction value table 113 in which the correction value corresponding to the density value is recorded in advance for the density value of the intermediate tone area pixels at the extracted edge vicinity of the raster data, and correction is performed using the correction value.

The halftone dot generating section 116 generates halftone dots (the generated halftone image data is called halftone image data hereinafter) from the corrected raster data based on the halftone dot reference data in the halftone dot reference data storage section 115, and the image output control section 117 sends halftone dot image data along with output command signals to the color laser printer 2 via the communication section 118. The halftone dot generation that occurs here refers to forming halftone dots of pixels in a prescribed area and converting the halftone dots to image data which indicates the lightness or darkness by the size of the halftone dots.

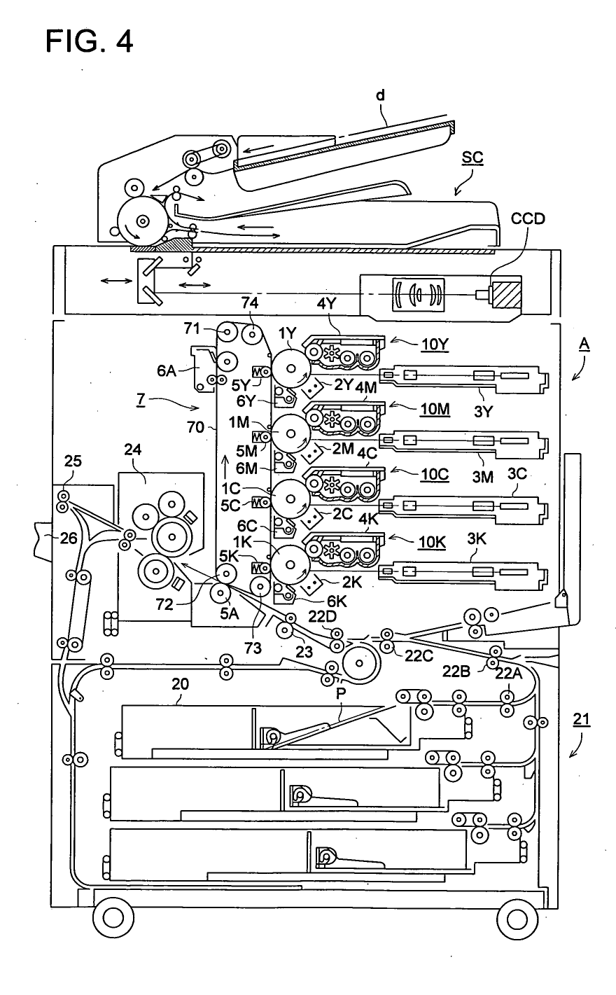

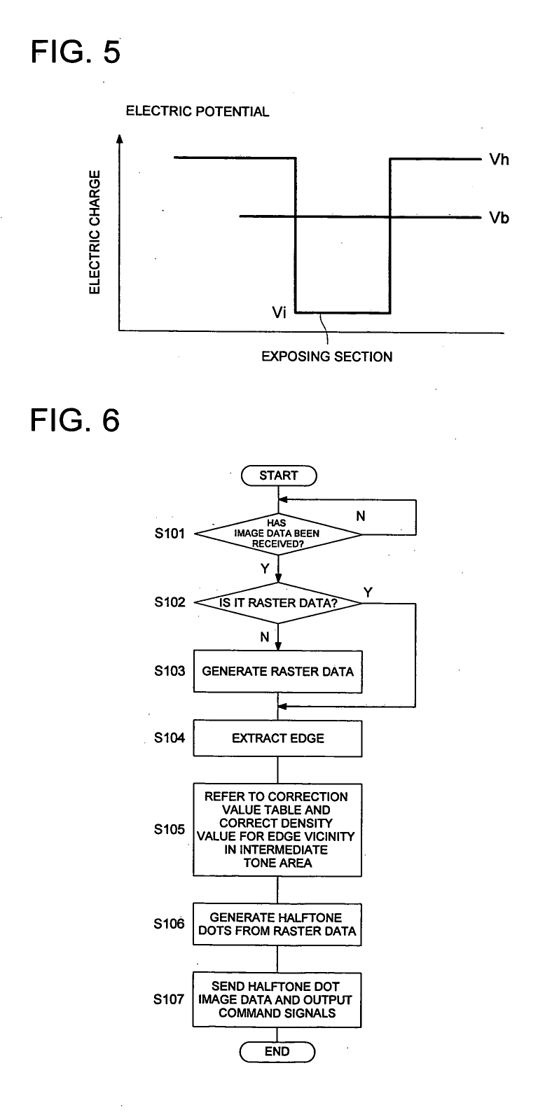

The color laser printer 2 is such an image forming apparatus that employs an electro-photographic method for forming an image and is generally called as a tandem-type color copier. As shown in FIG. 4, the color laser printer 2 is provided with an image-reading section SC for reading an image residing on a document when copying the document, image forming sections 10Y, 10M, 10C, 10K, and exposing sections 3Y, 3M, 3C, 3K for respectively forming each of unicolor images of Yellow, Magenta, Cyan and Black, an intermediate transfer unit 7, a paper feeding section 21 and a fixing unit. Although, in the example embodied in the present invention, the tandem-type color copier is employed as the color laser printer 2, it is applicable that the color laser printer 2 is, for instance, a tandem-type color printer, since the copy function is not necessary for implementing the present invention.

The image forming sections 10Y, 10M, 10C, 10K are disposed in a vertical direction as a tandem alignment, while the intermediate transfer member 70, which is shaped in a semiconductor endless belt and rotatably threaded on rollers 71, 72, 73, 74, is disposed at the left side of photoreceptor drums 1Y, 1M, 1C, 1K as shown in the drawing.

Further, the intermediate transfer member 70 is driven by an intermediate-transfer member driving roller 71 coupled to the driving device (not shown in the drawings), so as to rotate in a direction indicated by the arrow in the drawing.

The image forming section 10Y for forming the unicolor image of color Y (Yellow) includes a charging device 2Y, an exposing section 3Y, a developing device 4Y, a first transfer roller 5Y and a cleaning device 6Y, which are arranged around the photoreceptor drum 1Y.

The image forming section 10M for forming the unicolor image of color M (Magenta) includes a charging device 2M, an exposing section 3M, a developing device 4M, a first transfer roller 5M and a cleaning device 6M, which are arranged around the photoreceptor drum 1M.

The image forming section 10C for forming the unicolor image of color C (Cyan) includes a charging device 2C, an exposing section 3C, a developing device 4C, a first transfer roller 5C and a cleaning device 6C, which are arranged around the photoreceptor drum 1C.

The image forming section 10K for forming the unicolor image of color K (Black) includes a charging device 2K, an exposing section 3K, a developing device 4K, a first transfer roller 5K and a cleaning device 6K, which are arranged around the photoreceptor drum 1K.

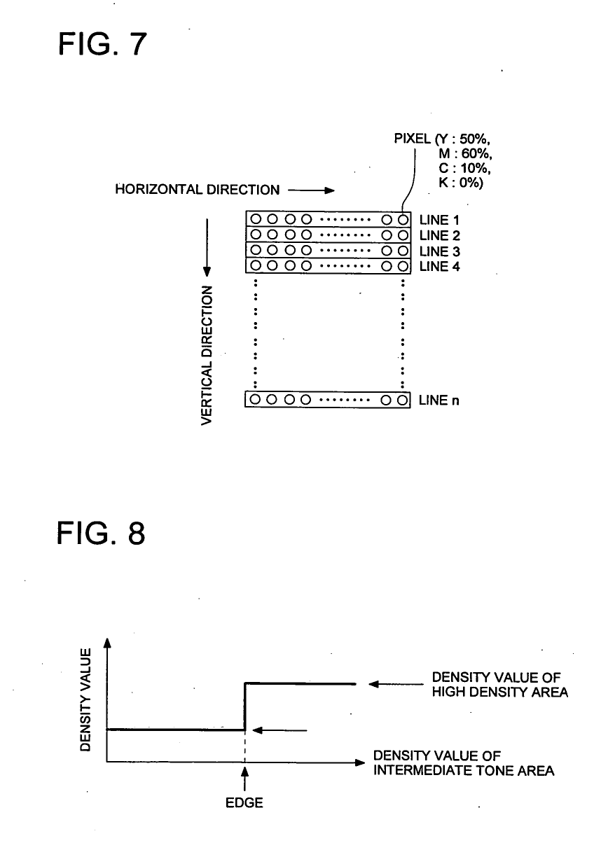

When the halftone-dot image data are transmitted to the color laser printer 2 from the control apparatus 1, the charging devices 2Y, 2M, 2C, 2K uniformly charge the surface of the photoreceptor drums 1Y, 1M, 1C, 1K to a predetermined polarity and a predetermined electrostatic potential, while rotating the photoreceptor drums 1Y, 1M, 1C, 1K in the directions indicated by the arrows in the drawing. Then, in each of the exposing sections 3Y, 3M, 3C, 3K, a laser diode (not shown in the drawings) is modulated to emit a modulated laser beam based on unicolor halftone-dot image data of the corresponding color, in order to scan the modulated laser beam onto corresponding one of the photoreceptor drums 1Y, 1M, 1C, 1K in a direction orthogonal to the rotating direction of each of the photoreceptor drums 1Y, 1M, 1C, 1K, so that an electrostatic latent image is formed on each of the photoreceptor drums 1Y, 1M, 1C, 1K by the rotating operation for each photoreceptor drum and the repetitions of the scanning operation for the modulated laser beam. Hereinafter, the scanning direction of the modulated laser beam is defined as a main-scanning direction, the rotating direction of each photoreceptor drum is defined as a sub-scanning direction, and the rotation of each photoreceptor drum is defined as a movement of photoreceptor drum in a sub-scanning direction. For instance, as shown in FIG. 7, when the unicolor image is exposed onto the corresponding surface of the photoreceptor drums 1Y, 1M, 1C, 1K by scanning the modulated laser beam after the charging devices 2Y, 2M, 2C, 2K respectively charge the photoreceptor drums 1Y, 1M, 1C, 1K at electrostatic potential Vh of the negative polarity, the electrostatic potential of the exposed area is drastically reduced to electrostatic potential Vi so as to form the electrostatic latent image. Successively, respective unicolor toner images are formed by the developing devices 4Y, 4M, 4C, 4K.

Further, the first transfer rollers 5Y, 5M, 5C, 5K are controlled to be selectively activated, so as to press-push the intermediate transfer member 70 against the photoreceptor drums 1Y, 1M, 1C, 1K, respectively.

According to the abovementioned process, the unicolor toner images, formed on the photoreceptor drums 1Y, 1M, 1C, 1K by means of the image forming sections 10Y, 10M, 10C, 10K, are sequentially transferred onto the intermediate transfer member 70, so as to form a full color toner image synthesized from the unicolor toner images.

A paper P, serving as an image-recording medium and accommodated in a paper feeding cassette 20, is fed by a paper feeding unit 21 and is conveyed to a second transfer roller 5A through a plurality of intermediate rollers 22A, 22B, 22C, 22D and a registration roller 23, so that the full color toner image, residing on the intermediate transfer member 70, is transferred onto the paper P at a time by means of the second transfer roller 5A.

Incidentally, the second transfer roller 5A press-contacts the roller 72 while putting the intermediate transfer member 70 and the paper P between them, only when the paper P passes through this point to achieve the second transferring operation.

On the other hand, after the second transferring operation, for transferring the full color toner image onto the paper P by means of the second transfer roller 5A, is completed, the paper P is separated from the intermediate transfer member 70 due to the curvature separating action, and then, residual toner are removed from the intermediate transfer member 70 by means of a cleaning unit 6A.

The paper P, onto which the full color toner image is already transferred, is conveyed into a fixing device 24 to fix the full color toner image onto the paper P, and then, is nipped by an ejecting roller 25 so as to eject the paper P onto an ejecting tray disposed outside the apparatus.

According to the configuration mentioned in the above, the controlling apparatus can convert the image data to the halftone dot image data, and the color laser printer 2 can create the color proof or the final product, based on the halftone dot image data.

(Image Output Method)

Next the steps in the method for outputting images, which are performed in the image outputting system, will be described using the flowchart in FIG. 6. FIG. 6 is a flowchart showing the processing steps of the controlling apparatus 1.

When the controlling apparatus 1 receives the image data (Y in Step S101; Note that Step S101 will be abbreviated to S101 hereinafter and this is the case for the other steps as well), if the image data has been made into raster data at the RIP4 (Y in S102), S104 is the next step, and in the case where it is vector data (N in S102) raster data is generated by the analysis processing section 111 (S103) and then the process proceeds to S104.

The structure of the raster data will be described in the following. The raster data is data in which pixels indicated by the density value of each of the colors are arranged. However, as shown in more detail in FIG. 7, the plurality of pixels that are arranged in the horizontal direction at a prescribed interval (resolution) form line 1 and a line is also formed from the pixels which are arranged at a prescribed interval in the vertical direction and the density value of the pixels are indicated by the halftone % for each of the colors Y, M, C, and K. In addition, in this example, the color laser printer 2 uses the horizontal direction, or in other words, the line direction as the scanning direction for the laser beam and the image is thereby formed. The horizontal direction in FIG. 6 is used as the main scanning direction, while the vertical direction is the sub-scanning direction.

In S104, the edge extraction section 112 extracts the edge which is the boundary between the intermediate tone area and the high density area which has a density value that is higher than that of the intermediate tone area of the raster data shown in FIG. 8.

The edge extraction is performed with the edge being the transition point from the intermediate tone area to the high density area which has a density value that is higher than of the intermediate tone area in the sub-scanning direction for example. The extraction may also be done with the edge being the transition point from the intermediate tone area to the high density area in the main scanning direction. In addition, edge extraction may be performed for a intermediate tone area which is not greater than a prescribed density value or with the edge being determined as the case where the difference in the density value between the intermediate tone area and the high density area is not greater than a prescribed value. Furthermore, extraction may be done with the edge being determined as the case where a prescribed number of pixels are continuous both before and after the transition point of the intermediate tone area and the high density area. Also, in the case where detection as an edge is performed, when the high density area is a beta section (halftone %=100%), density reduction can be suppressed in particular in the edge vicinity of beta section of the intermediate tone area in which density reduction tends to occur.

Furthermore the edge extraction of the extraction section 112 is not limited to raster data, and vector data may be used to extract the edge which is the boundary between the intermediate tone area and the high density area from the drawing information for each object.

In addition, in S105, the correction section 114 corrects for each color, the density value of the pixels for the intermediate tone area of the edge vicinity that was drawn by referring to correction value table 113.

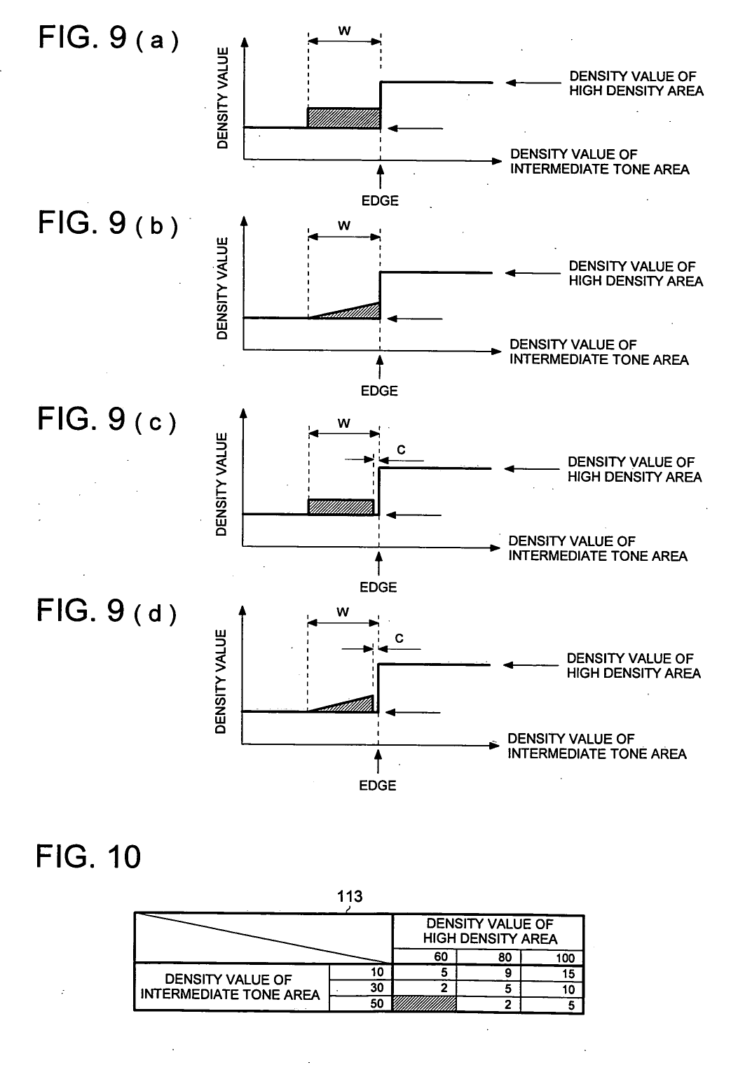

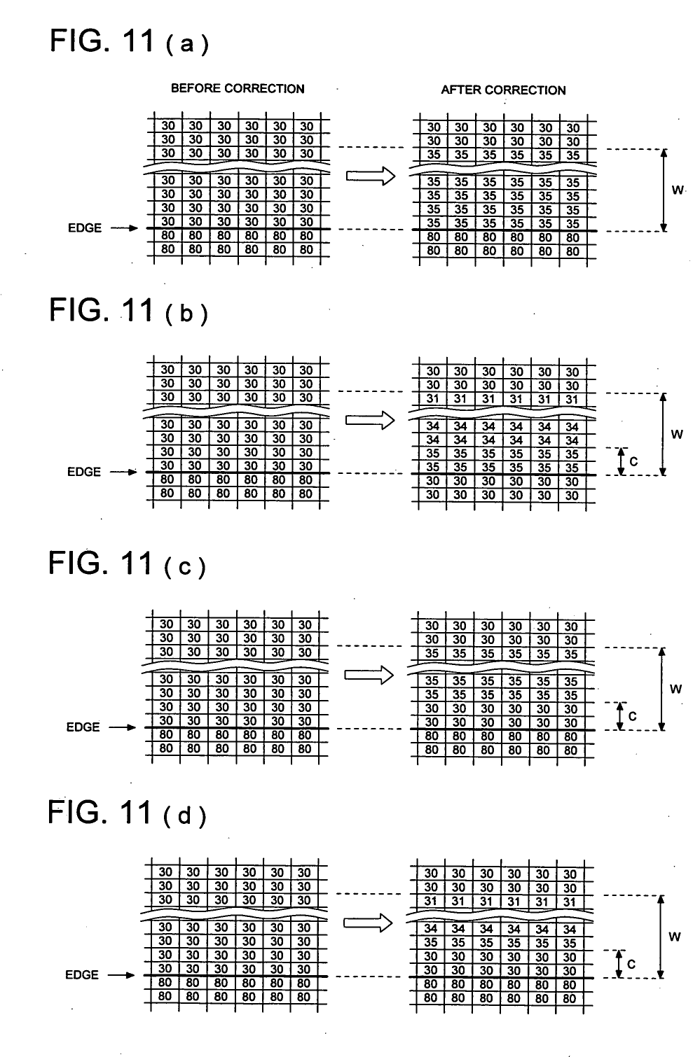

One example of correction of the density value is described using FIGS. 9(a) through 9(d), FIG. 10 and FIGS. 11(a) through 11(d). For example as shown in FIG. 9(a), correction of the density value for the width W of the edge vicinity area is performed. Due to this correction, an image can be obtained in which density reduction in the intermediate tone area of the edge vicinity is suppressed. In addition, if the width (W) is in the range between 1 mm and 20 mm, the effect on density reduction is favorable. The correction amount of the density value is determined from the density value of the intermediate tone area and the density value of the high density area for example. One example is shown in FIG. 10, but FIG. 10 is the correction value table 113 which is determined so as to correspond with the combination of density value for the intermediate tone area and the density value of the high density area such that the correction is carried out in the case where the halftone % of the density value of the intermediate tone area is 1% to 60% and the halftone % of the high density area is 60% to 100%, and also the difference of the halftone % is of the high density area and the intermediate tone area is 30 or more. However, because density reduction tends to occur in the case where the difference between the density value of the high density area and the intermediate tone area is large, the setting may be such that correction is done when the halftone % difference between the high density area and the intermediate tone area is 60% or more and in this case, the sharp appearance of the edge can be maintained as in the case where the halftone % difference between the high density area and the intermediate tone area is small. In addition, the correction values that are recorded in the correction value table 113 are values which determined in advance by performing experiments. In the correction value table 113 shown in FIG. 10, the correction value is determined for a combination of three halftone % values for the intermediate tone area and three halftone % values for the high density area, but combinations of other halftone % values for the intermediate tone area and halftone % values for the high density area maybe determined by interpolation. For example, as shown in FIG. 11(a), the density value of the raster data is corrected. FIG. 11(a) shows the density value prior to correction and the density value after correction. In addition, in the case where the correction value is set in accordance with density value of the intermediate tone area, the correction is performed in accordance with the density value of the intermediate tone area, and in the case where the correction value is set in accordance with density value of the high density area, the correction is performed in accordance with the density value of the high density area.

In addition, as shown in FIG. 9(b), the density value for the width W of the edge vicinity is corrected in an inclined state such that the correction amount in the edge vicinity is determined as described above, and the correction amount within the width W is small (0 in the figures). As a result of this type of correction, an image is obtained in which the difference between the density and the corrected portion and the original intermediate tone area is suppressed. For example, the density value for the raster data is corrected as shown in FIG. 11(b). FIG. 11(b) shows the density values prior to correction and after correction.

As shown in FIG. 9(c) the density value is corrected for the width (W) in the edge vicinity at a distance of C away from the edge. By providing this distance C, the appearance of the edge is kept sharp. This distance C may, for example, be about 0.1 mm, and in the case where the resolution of the color laser printer is 600 dpi (dot per inch) it should be set at about 0.085 mm or more for 2 dots. However, in the case where the distance exceeds 0.4 mm density reduction in the intermediate tone area of the edge vicinity starts to become obvious. Thus, when the distance C is between 0.08 mm and 0.4 mm, and more preferably between 0.2 mm and 0.3 mm, the appearance of the edge is sharp and is favorable for density reduction of the intermediate tone area of the edge vicinity. For example, the density value for the raster data is corrected as shown in FIG. 11(c). FIG. 11(c) shows the density values prior to correction and after correction.

In addition, as shown in FIG. 9(d), the correction may be done in an inclined state such that the correction amount within the width W in the edge vicinity is small when the distance from the edge is C. For example, the density value for the raster data is corrected as shown in FIG. 11(d). FIG. 11(d) shows the density values prior to correction and after correction.

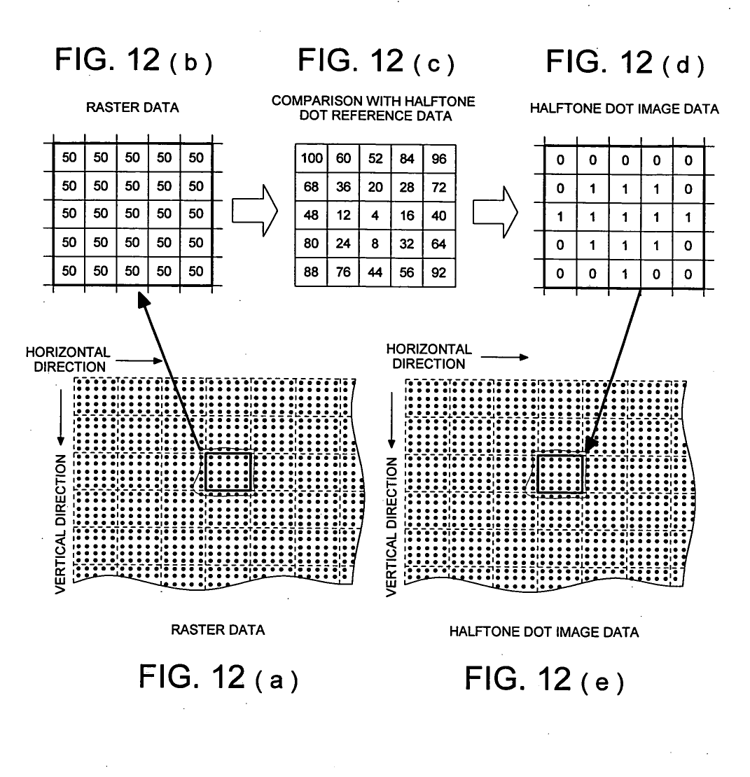

Furthermore, in S106, the raster data for each of the corrected colors is converted to halftone dot image data based on the halftone dot reference data in the halftone dot reference data storage section 115. One example of halftone dot generation will be described in which the raster data is divided into regions of 5 pixels×5 pixels as shown in FIG. 12(a), and in this description, in each area is formed of pixels in which one halftone dot is indicated by a binary value. For example, halftone dot reference data comprising threshold values arranged in accordance with prescribed rules is stored in the halftone dot reference data storage section 115 as shown in FIG. 12(c) so that the size of the halftone dot within the area can be changed to large or small in accordance with whether the density value of the raster data is large or small. FIG. 12(b) shows the density value for each pixel of the area of 5 pixels×5 pixels for the raster data shown in FIG. 12(a) as halftone %. However, the halftone % of each pixel is compared to the threshold value for the position corresponding to the halftone dot reference data, and if the halftone % is the same or larger than the threshold value it is assigned the value of “1”, while if it is less than the threshold value, it is assigned a value of 0. The raster data shown in FIG. 12(b) is converted as shown in FIG. 12(b). FIG. 12(d) corresponds to the position in the raster data shown in FIG. 12(a) of the areas shown in FIG. 12(b) of the halftone dot image data shown in FIG. 12(e). In addition, halftone dots are formed by the pixels assigned “1” in the area of 5 pixels×5 pixels as shown in FIG. 12(d). In the example described here, the halftone dot is formed of pixels which are indicated by binary values, but halftone dots may be generated using multiple halftone dot reference data including threshold value groups arranged according to prescribed rules such that the halftone dot may be formed of pixels that are indicated by multiple values.

In addition, in S107, the image output control section 117 sends the halftone image data for each color as well as output command signals to the color laser printer 2 via the communication section 118.

The color laser printer 2 forms color images based on the binary data shown in each of the pixels of the halftone image data for each color, and the color image is output as a color proof or a final product. Needless to say, in the case where each of the pixels for the halftone image data is a multiple value, the color image is formed based on multiple value data and output as a color proof or final product.

In addition, in the above description, the controlling apparatus 1 generates halftone dots from the corrected raster data, and sends the halftone image data to the color laser printer 2, and the color printer 2 forms the halftone dot images based on the halftone image data, but the controlling apparatus may send the corrected raster data as it is to the color laser printer 2 and the color laser printer 2 forms images based on the density value indicated by the raster data for each pixel and outputs the images. In this case also, the effect on density reduction of the edge vicinity is made favorable by correcting the density value of the intermediate tone area of the edge vicinity which is the boundary between the intermediate tone area and the high density area whose density value is higher than that of the intermediate tone area.

### Second Embodiment

Next, the second embodiment of this invention will be described. It is to be noted that description of structures that are substantially similar to those of the first embodiment will be omitted and mainly the differences will be described.

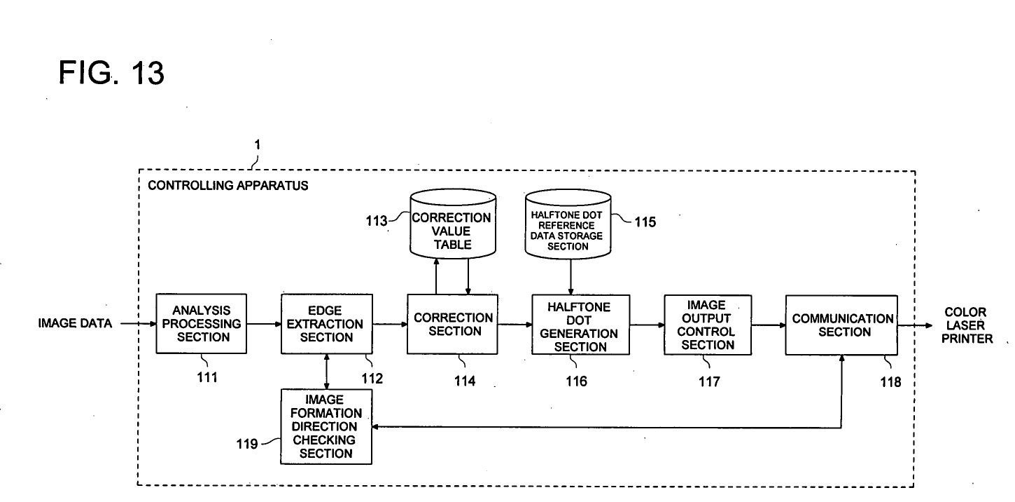

In this embodiment the color laser printer 2 is one in which: the vertical direction and horizontal direction sizes of the halftone dot image data that is sent from the controlling apparatus 1 and the vertical direction and horizontal direction sizes of the paper P stored in the paper feeding cassette 20 are compared and in the case where it is possible to automatically rotate the image formation direction with respect to the paper P by 90 degrees such that the halftone dot image data can fit on one sheet of the paper P, the controlling apparatus 1 checks whether the color laser printer 2 performs image formation by rotating the image with respect to the paper P based on the halftone dot image data obtained by conversion of the image data, or whether the image will not be rotated. This is done prior to extraction of the edge which is the boundary between the intermediate tone area and the high density area whose density value is higher than that of the intermediate tone area for the raster data which will be converted into the image data as shown in the functional block diagram of FIG. 13. An image formation direction checking section 119 (checking section) is included which determines the direction corresponding to the sub-scanning direction in the raster data. The edge extraction section 112 extracts the edge as the transition point from the intermediate tone area to the high density area whose density value is higher than that of the intermediate tone area in the previously determined direction and the correction section 114 corrects the density value of the pixels of the intermediate tone area of the edge vicinity that was extracted.

The image formation direction checking section 119 may, for example, be one in which checking is done to determine whether image formation is performed by rotating the image with respect to the color laser printer 2 based on the size in the vertical direction and the horizontal direction of image that is obtained by calculation from the raster data that will be converted to halftone dot image data or whether image formation is performed without rotating the image. Alternatively, the image formation direction checking section may be one in which the size information for the vertical direction and the horizontal direction of the paper P that is accommodated in the feeding cassette 20 and direction information for rotating the halftone image data are retrieved from the color laser printer 2 and the size information for the vertical direction and the horizontal direction of the paper P and the size in the vertical direction and the horizontal direction of the image obtained by calculation from the raster data which is to be converted into halftone image data are compared, and a determination is made as to whether the color laser printer 2 performs image formation with rotation or without rotation, and the image formation direction is thereby checked.

(Image Output Method)

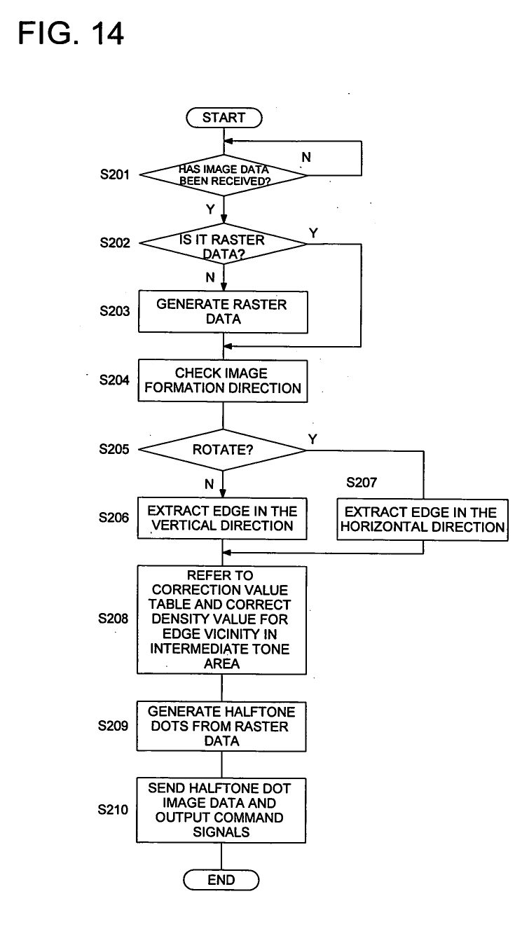

Next the steps in the method for outputting images which is performed in the image outputting system of the second embodiment will be described using the flowchart in FIG. 14. FIG. 14 is a flowchart showing the processing steps in the controlling apparatus 1.

When the controlling apparatus 1 receives the image data (Step S201), if the image data has been made into raster data at the RIP4 (Y in S202), S204 is the next step, and in the case where it is vector data (N in S202) raster data is generated by the analysis processing section 111 (S203) and then the process proceeds to S204.

In S204 the image formation direction checking section 119 checks the direction of image formation as described above. Given that in this example the rotation direction for image formed at the color laser printer 2 is 90 degrees in the clockwise direction, in the case where the image is rotated and image formation is performed (Y is S205), the image formation direction checking section 119 determines that the sub-scanning direction is the horizontal direction shown in the raster data in FIG. 7. The edge extraction section 112 extracts the edge as the transition point from the intermediate tone area to the high density area whose density value is higher than that of the intermediate tone area in the horizontal direction thereof (S207) and in the case where image formation is performed without rotation (N in S205), the image formation direction checking section 119 determines that the vertical direction shown in the raster data in FIG. 7 is the sub-scanning direction. The edge extraction section 112 extracts the edge as the transition point from the intermediate tone area to the high density area whose density value is higher than that of the intermediate tone area in the vertical direction thereof (S206).

In S208, the correction section performs correction of the density value of the pixels in the intermediate tone area of the edge that has been extracted in the same manner as the first embodiment.

In S209, the raster data that has been corrected for each color is converted to halftone dot image data based on the halftone dot reference data in the halftone dot reference data storage section 115. In S107, the image output control section 117 sends the halftone image data for each color as well as output command signals to the color laser printer 2 via the communication section 118.

By checking the image formation direction in the color laser printer in this manner and correcting the density value of the image data of the edge vicinity in the sub-scanning direction at the time of image formation, even in the case where the color printer automatically rotates the image data in accordance with size of the image data in the vertical direction and the horizontal direction to form the image data, it is possible to suppress density reduction of the intermediate tone area which tends to occur in the sub-scanning direction.

### Program and the Information Recording Medium for Recording the Program

It is to be noted that the programs for executing the processes performed in the controlling apparatus 1 including the image outputting system, or more specifically, the processing steps of the image output method described with reference to FIG. 6 or FIG. 14, in the computer of the controlling apparatus 1 are incorporated into the computer main body of the controlling apparatus 1, or alternatively the programs may be recorded in an information recording medium which can be connected to the computer and read by the computation processing section section 101 which is the computing section that is incorporated into the computer main body in the same manner as above, and the programs are thereby executed.

It is to be noted that specific examples of the information recording medium include semiconductor memory such as ROM, RAM, and flash memory, HDD, and memory devices such as integrated circuits, optical disks, magneto-optic disk (CD-ROM/DVD-RAM/DVD-ROM/MO and the like), and magnetic recording media such as magnetic disks (hard disk, floppy (registered trademark) disks, ZIP and the like).

It is to be noted that the image outputting system of this embodiment, the image output method, the program for executing the method and the computer-readable information recording medium on which the program is recorded illustrates a favorable embodiment of this invention but is not intended to exclude other embodiments.

According to the present invention, the following effects can be attained.
(1) By correcting a density value, residing within the intermediate tone area and located in the vicinity of the edge, being a boundary between the intermediate tone area and the high density area where the density value is higher than that of the intermediate tone area, it becomes possible to suppress density reduction occurring at a region in the vicinity of the edge within the intermediate tone area.
(2) By correcting a density value, residing within the intermediate tone area and located in the vicinity of the edge, being a boundary in the sub-scanning direction between the intermediate tone area and the high density area where the density value is higher than that of the intermediate tone area, it becomes possible to suppress density reduction, which tends to occur in the sub-scanning direction at a region in the vicinity of the edge within the intermediate tone area.
(3) Density reduction in the intermediate tone area of the edge vicinity which tends to occur in the sub-scanning direction is suppressed by checking the direction of image formation in the image outputting apparatus in the case where the image outputting apparatus can change the direction of image formation with respect to the image recording medium to correspond with the image size and the size of the image recording medium that is provided, extracting the edge which is the boundary between the intermediate tone area and the high density area whose density value is higher than that of the intermediate tone area in the direction corresponding to the sub-scanning direction at the time of image formation, and correcting the density value of the intermediate tone area of the edge vicinity.
(4) Density reduction is suppressed by making the difference in the density values between the intermediate tone area and the high density area at the time of edge extraction above a prescribed value; density reduction in the edge vicinity can be suppressed in the case where the value is not less than the prescribed value; and sharpness can be maintained in the case where the value less is than the prescribed value.
(5) Density reduction which tends to occur in the sub-scanning direction in the case where high density area is a solid color area can be suppressed.
(6) Density reduction of the edge vicinity can be suppressed while edge sharpness is maintained by correcting the density value which is not less than a prescribed distance from the extracted edge.
(7) Density reduction of the edge vicinity can be suppressed while edge sharpness is favorably maintained if the prescribed distance from the extracted edge to be in a range between 0.08 mm and 0.4 mm.
(8) Because correction is performed using a smaller correction at a position far from the edge than at a position close to the edge, density reduction of the edge vicinity can be suppressed while an image is obtained in which the difference between the density of the corrected portion and the original intermediate tone area is suppressed.
(9) Correction is performed using a correction value which corresponds with the density of the intermediate tone area.
(10) Correction is performed using a correction value which corresponds with the density of the high density area.
(11) Correction is performed using a correction value which corresponds with the combined density of the intermediate tone area and the density of the high density area.
(12) Density reduction in the edge vicinity can be suppressed in the case where the image outputting apparatus superposes images of a plurality of colors and outputs a color images.
(13) According to the image outputting method of the present invention, density reduction is suppressed for the intermediate tone area of the edge vicinity by correcting the density value of the intermediate tone area in the edge vicinity which is the boundary between the intermediate tone area and the high density area whose density value is higher than that of the intermediate tone area.
(14) According to the image outputting method of the present invention, density reduction in the intermediate tone area of the edge vicinity which tends to occur in the sub-scanning direction is suppressed by: checking the direction of image formation in the image outputting apparatus in the case where the image outputting apparatus can change the direction of image formation corresponding with respect to the image recording medium to correspond with the image size and the size of the image recording medium that is provided; extracting the edge which is the boundary between the intermediate tone area and the high density area whose density value is higher than that of the intermediate tone area in the direction corresponding to the sub-scanning direction at the time of image formation; and correcting the density value of the intermediate tone area of the edge vicinity.
(15) It becomes possible to provide a program for implementing the image output method on a computer.
(16) It becomes possible to provide an information recording medium in which the program is recorded in a computer readable format.

Disclosed embodiment can be varied by a skilled person without departing from the spirit and scope of the invention.

1. A system for outputting an image formed on a recording medium, based on image data transmitted through a network, said system comprising:
an image outputting apparatus to output said image formed on said recording medium; and
a controlling apparatus that receives said image data transmitted through said network to output processed-image data generated from said image data, and controls said image outputting apparatus so as to form said image on said recording medium, based on said processed-image data;
wherein said controlling apparatus includes:
an extracting section to extract an edge, defined as a boundary at which a density value varies from an intermediate tone area to a high density area where said density value is higher than that of said intermediate tone area, based on whole density values represented by said image data; and
an correcting section to correct a density value, residing within said intermediate tone area and located in a vicinity of said edge, based on a correction value determined in advance.

2. The system of claim 1,
wherein, in said image outputting apparatus, a laser beam, modulated according to said processed-image data, is scanned onto said recording medium in a main scanning direction, while said recording medium is moving in a sub-scanning direction being orthogonal to said main scanning direction, in order to form said image on said recording medium by repeating main-scanning operations of said laser beam and moving operations of said recording medium in said sub-scanning direction; and
wherein said extracting section extracts said edge, at which said density value varies from said intermediate tone area to said high density area in a direction corresponding to said sub-scanning direction.

3. The system of claim 1,
wherein, said density value of said high density area is equal to or greater than such a value that is higher than that of said intermediate tone area by a predetermined value.

4. The system of claim 1,
wherein said correcting section corrects said density value, being apart from said edge by a predetermined distance or another distance longer than said predetermined distance, based on said correction value determined in advance.

5. The system of claim 4,
wherein said predetermined distance is in a range of 0.08-0.4 mm.

6. The system of claim 1,
wherein the larger a distance from said edge becomes, the smaller said correcting section makes said correction value, so as to correct said density value.

7. The system of claim 1,
wherein said correction value is determined corresponding to any one of a first density value belonging to said intermediate tone area, a second density value belonging to said high density area, and a combination of said first density value and said second density value.

8. The system of claim 1,
wherein said image outputting apparatus outputs a full color image, serving as said image, formed by overlapping a plurality of unicolor images with each other onto said recording medium, and
wherein said image data corresponds to each of said plurality of unicolor images, and with respect to each of said plurality of unicolor images, said controlling apparatus controls said image outputting apparatus so as to correct said density value, based on said correction value determined in advance for every unicolor.

9. A system for outputting an image formed on a recording medium, based on image data transmitted through a network, said system comprising:
an image outputting apparatus to output said image formed on said recording medium; and
a controlling apparatus that receives said image data transmitted through said network to output processed-image data generated from said image data, and controls said image outputting apparatus so as to form said image on said recording medium, based on said processed-image data;
wherein, in said image outputting apparatus, a laser beam, modulated according to said processed-image data, is scanned onto said recording medium in a main scanning direction, while said recording medium is moving in a sub-scanning direction being orthogonal to said main scanning direction, in order to form said image on said recording medium by repeating main-scanning operations of said laser beam and moving operations of said recording medium in said sub-scanning direction; and
wherein said image outputting apparatus is capable of changing an image forming direction of said image to be formed on said recording medium, corresponding to an image size and a size of said recording medium; and
wherein said controlling apparatus includes:
a direction confirming section to confirm said image forming direction of said image to be formed on said recording medium, based on said image data, so as to determine said image forming direction as said sub-scanning direction;
an extracting section to extract an edge, defined as a boundary at which a density value varies from an intermediate tone area to a high density area where said density value is higher than that of said intermediate tone area, in said image forming direction determined by said direction confirming section, based on whole density values represented by said image data; and
an correcting section to correct a density value, residing within said intermediate tone area and located in a vicinity of said edge, based on a correction value determined in advance.

10. The system of claim 9,
wherein, said density value of said high density area is equal to or greater than such a value that is higher than that of said intermediate tone area by a predetermined value.

11. The system of claim 9,
wherein said correcting section corrects said density value, being apart from said edge by a predetermined distance or another distance longer than said predetermined distance, based on said correction value determined in advance.

12. The system of claim 11,
wherein said predetermined distance is in a range of 0.08-0.4 mm.

13. The system of claim 9,
wherein the larger a distance from said edge becomes, the smaller said correcting section makes said correction value, so as to correct said density value.

14. The system of claim 9,
wherein said correction value is determined corresponding to any one of a first density value belonging to said intermediate tone area, a second density value belonging to said high density area, and a combination of said first density value and said second density value.

15. The system of claim 9,
wherein said image outputting apparatus outputs a full color image, serving as said image, formed by overlapping a plurality of unicolor images with each other onto said recording medium, and
wherein said image data corresponds to each of said plurality of unicolor images, and with respect to each of said plurality of unicolor images, said controlling apparatus controls said image outputting apparatus so as to correct said density value, based on said correction value determined in advance for every unicolor.

16. A method for outputting an image formed on a recording medium, based on image data transmitted through a network, said method comprising the steps of:
receiving said image data transmitted through said network;
extracting an edge, defined as a boundary at which a density value varies from an intermediate tone area to a high density area where said density value is higher than that of said intermediate tone area, based on whole density values represented by said image data;
correcting a density value, residing within said intermediate tone area and located in a vicinity of said edge, based on a correction value determined in advance, so as to generate processed-image data generated from said image data; and
outputting said image that is formed on said recording medium, based on said processed-image data generated in said correcting step.

17. The method of claim 16,
wherein a laser beam, modulated according to said processed-image data, is scanned onto said recording medium in a main scanning direction, while said recording medium is moving in a sub-scanning direction being orthogonal to said main scanning direction, in order to form said image on said recording medium by repeating main-scanning operations of said laser beam and moving operations of said recording medium in said sub-scanning direction; and
wherein an image forming direction of said image to be formed on said recording medium can be changed, corresponding to an image size and a size of said recording medium; and the method further comprising the steps of:
confirming said image forming direction of said image to be formed on said recording medium, based on said image data; and
determining said image forming direction as said sub-scanning direction;
wherein, in said extracting step, said edge is extracted in said image forming direction determined in said determining step.

18. The method of claim 16,
wherein, said density value of said high density area is equal to or greater than such a value that is higher than that of said intermediate tone area by a predetermined value.

19. The method of claim 16,
wherein said density value, being apart from said edge by a predetermined distance or another distance longer than said predetermined distance, is corrected, based on said correction value determined in advance.

20. The method of claim 19,
wherein said predetermined distance is in a range of 0.08-0.4 mm.
